(19) United States
(12) Patent Application Publication
(10) Pub. No.: US 2006/0020677 A1
(43) Pub. Date: Jan. 26, 2006

(54) Providing sender-specific notifications of received e-mail messages

(75) Inventor: Walter V. von Koch, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/898,655

(22) Filed: Jul. 23, 2004

(51) Int. Cl. G06F 15/16

(52) U.S. Cl. 709/207

(57) ABSTRACT

Strategies are described for notifying a user who is using an instant messaging (IM) service of the receipt of an E-mail message. The user is notified of such E-mail message via a user interface presentation provided by IM message service. The notification specification involves informing the user of identity of the person who sent the E-mail message. One technique for conveying this information is to display visual indicia on the user interface presentation in proximity to the sender's name. The IM user is thus instantly apprised of who sent the E-mail message, without requiring the user to take burdensome steps by activating the E-mail service upon every receipt of an E-mail message. The user presentation can also display information regarding how many E-mail messages each individual identified in the user interface presentation has sent the IM user. The IM user presentation can also display supplemental information which identifies the subject matter of the received E-mail messages.

### TECHNICAL FIELD

This subject matter relates to strategies for integrating different kinds of message services. In a more particular implementation, this subject matter relates to strategies for alerting users who are using a first kind of messaging service of messages received via a second kind of messaging service.

### BACKGROUND

Two kinds of message services that enjoy significant popularity today are E-mail 9 services and instant messenger (IM) services. In E-mail services, E-mail functionality at a client device typically sends a text message with optional attachments to an addressee I using the traditional ampersand formulation; for instance, a text message might be addressed to a target recipient John Smith who works for company XYZ (with a domain name “xyzcompany.com”) using the following addressee information: JohnSmith@xyzcompany.com. The E-mail service typically sends the message through a TCP/IP network (e.g., the Internet) to a server associated with the domain name xyzcompany.com. The recipient, John Smith, can then, at his convenience, access the message by downloading it from the server to his own client device. Other popular E-mail services use web-enabled E-mail functionality, which allow senders and recipients to send E-mail messages without having E-mail functionality installed on their respective client devices. Microsoft Corporation's Outlook Express and Hotmail services provide two examples of E-mail services in wide use today.

On the other hand, IM services are generally designed to enable real time communication among participants who happen to be using their computer devices at the same time. That is, an IM service typically includes functionality for allowing an IM user to define a group of participants with whom the user frequently communicates. The IM service will then typically notify the IM user when any member of the thus-defined group happens to be on-line. The IM user then has the option of starting a communication session with one or more of the group members or joining an existing communication session. This prompts the IM service to open a user interface (UI) panel that will display an evolving sequence of textual messages transmitted among group members. When a participant goes off line, it is typically no longer possible to send that participant a message using the IM service.

Since E-mail services and IM services address somewhat different communication needs, many users prefer to use both kinds of services. For instance, users continue to favor E-mail for more formal electronic communication between clients. E-mail is also the preferred choice when it is desirable to send a message to a recipient regardless of whether that recipient is on-line at the moment of message transmission. Also, whether justified or not, E-mail messages may enjoy a greater expectation of security compared to some IM services. On the other hand, users commonly resort to IM services for relatively quick and informal conversations. While some IM services permit users to retain logs of IM conversations, there is generally no expectation that the user will do so in the normal course of using this service.

Using both E-mail services and IM services thus enhances the communication options available to users. However, this dual use also may introduce new challenges. For instance, the use of both services may require the user the repeatedly toggle between the two different kinds of service functionality. That is, after using an IM service for a length of time, the IM user may need to check their E-mail account to determine whether the IM user has received any E-mail messages in their inbox. Provisions exist for alerting a user that they have received E-mail while the user is using other applications. But these alerts do not provide a meaningful synopsis of the state of the user's E-mail inbox. Accordingly, the user may still find it necessary to activate their E-mail functionality to investigate what E-mail messages they have received while using another application, and to determine whether these E-mail messages require their immediate attention.

Accordingly, there is an exemplary need for more satisfactory techniques for integrating notifications provided by different messaging services, such as E-mail services and IM services.

### SUMMARY

According to one exemplary implementation, a method is described for notifying a user of a first message service of the arrival of a message received via a second message service. The method comprises: (a) activating the first message service to provide a user interface associated with the first message service; (b) receiving a notification that alerts the user that a sender has sent the user a message via the second message service; and (c) presenting the notification via the user interface provided by the first message service, wherein the notification identifies the sender of the message.

According to one exemplary implementation, the above-mentioned first message service is an instant messaging (IM) service and the above-mentioned second message service is an E-mail service.

Additional exemplary implementations are described in the following.

### BRIEF DESCRIPTION OF THE DRAWINGS

FIG. 1 shows an exemplary system for notifying a user of an instant messaging (IM) service of the receipt of an E-mail message.

FIGS. 2-4 show different exemplary scenarios that explain the operation of the system of FIG. 1.

FIGS. 5-8 shows exemplary user interface presentations through which the user can interact with the system of FIG. 1.

FIGS. 9-11 show procedures which illustrate the operation of the system of FIG. 1 in flowchart form.

FIG. 12 shows an exemplary computer environment for implementing aspects of the system of FIG. 1.

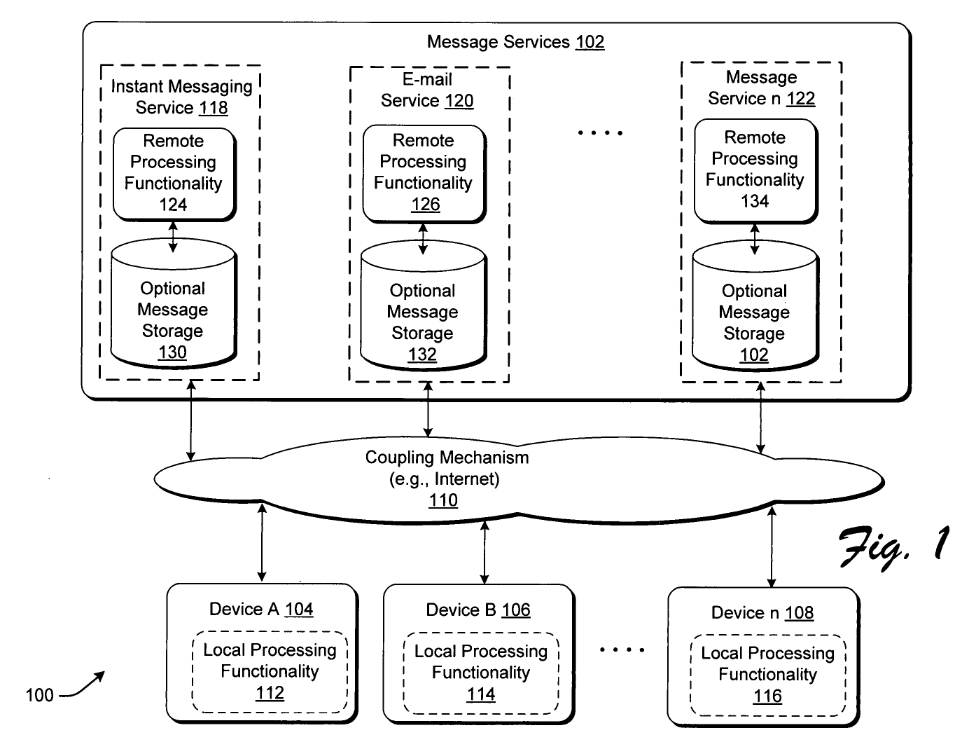

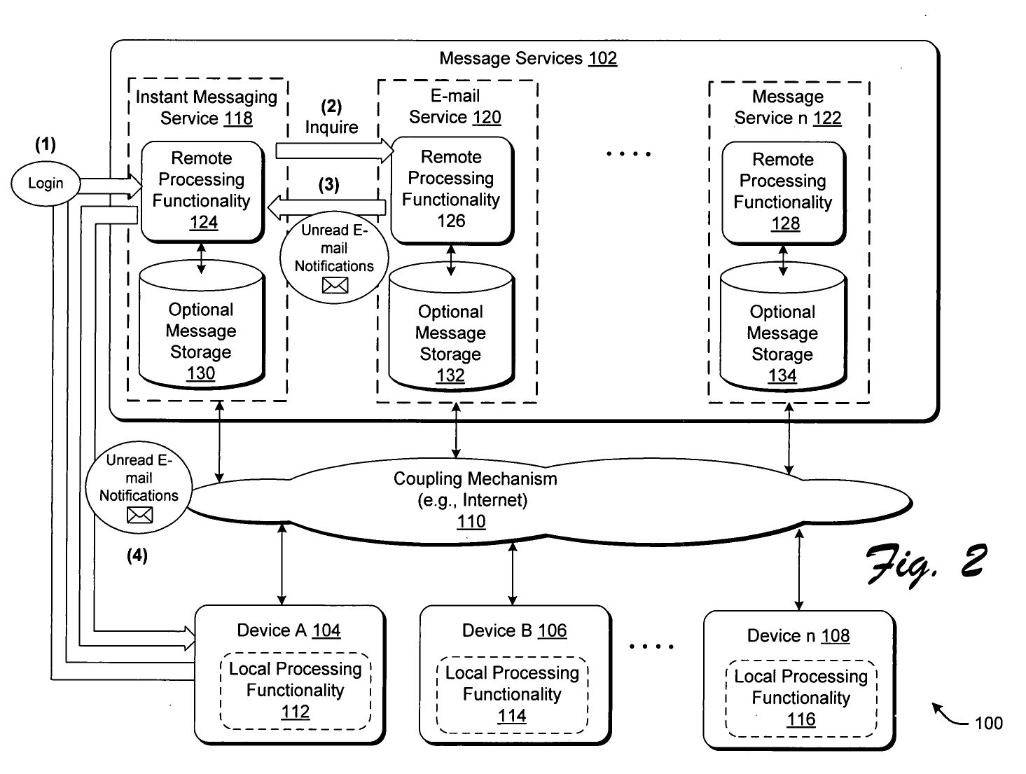

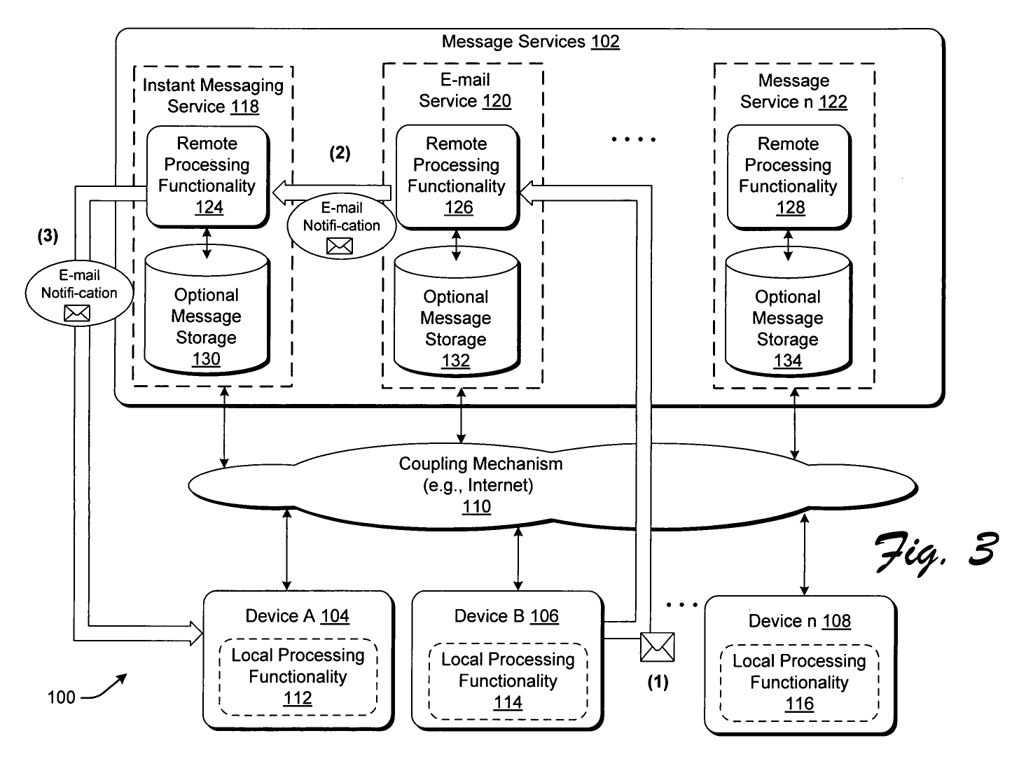

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The following description sets forth techniques for alerting a user of a first message service of messages received via a second message service. The alerting techniques are particularly configured to notify the user of the first message service of the respective identities of the individuals who sent the messages. This feature provides the user of the first message service with a useful summary of activity occurring within the second message service while the user is engaged in interacting with the first message service. This allows the user to decide whether they need to attend to the second message service without having to repeatedly activate and investigate the activities that have occurred with respect to the second message service every time they receive a message through that service.

The term “message service” refers to any functionality for transmitting messages among participants, including one-to-one transmission of messages and one-to-many transmission of messages. To facilitate discussion, the following description is specifically framed in the exemplary context where the first above-mentioned message service is an instant messaging (IM) service and the second above-mentioned messaging service is an E-mail service. IM services generally refer to any functionality for transmitting messages among participants who are concurrently online and attending to an ongoing conversation in some manner. E-mail services general refer to any functionality for transmitting messages to participants' inboxes irrespective of whether the participants are online at the time of message transmission. However, it should be noted that the principles described herein can be applied to other kinds or combinations of message services besides IM services and E-mail services. Further, the principles described herein can be applied to the case where messages received via multiple kinds of message services are forwarded to multiple other kinds of message services; in other words, for example, messages alerts pertaining to messages received by any of message services A, B, C, etc. can be forwarded to users via any of message services M, N, O, etc., and so forth.

Message services perform their ascribed tasks using logic that can be distributed over multiple sites. For instance, the message services may rely on logic allocated to one or more participant client sites as well as one or more server sites. Or the message services can be implemented without requiring that special logic be loaded at the client sites, as in the case of web-enabled message services. The term “service functionality” is used broadly herein to refer to any number of ways that messages services can be implemented, without necessarily referring to a particular technical implementation. Thus, reference to E-mail service functionality can encompass both client-resident functionality for transmitting and receiving messages as well as web-enabled functionality for transmitting and receiving messages. If reference is being made to specific functionality present at a local or remote site, then the phrases local functionality and remote functionality, respectively, will be used.

Generally, any of the functions described with reference to the figures can be implemented using software, firmware (e.g., fixed logic circuitry), manual processing, or a combination of these implementations. The term “logic, “module” or “functionality” as used herein generally represents software, firmware, or a combination of software and firmware. For instance, in the case of a software implementation, the term “logic,” “module,” or “functionality” represents program code that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

This disclosure includes the following sections. Section A describes an exemplary system for integrating E-mail alerts in an IM service. Section B describes exemplary user interface features for allowing a user to interact with the system of Section A. And Section C describes a series of flowcharts which describe the operation of the system of Section A.

A. Exemplary System

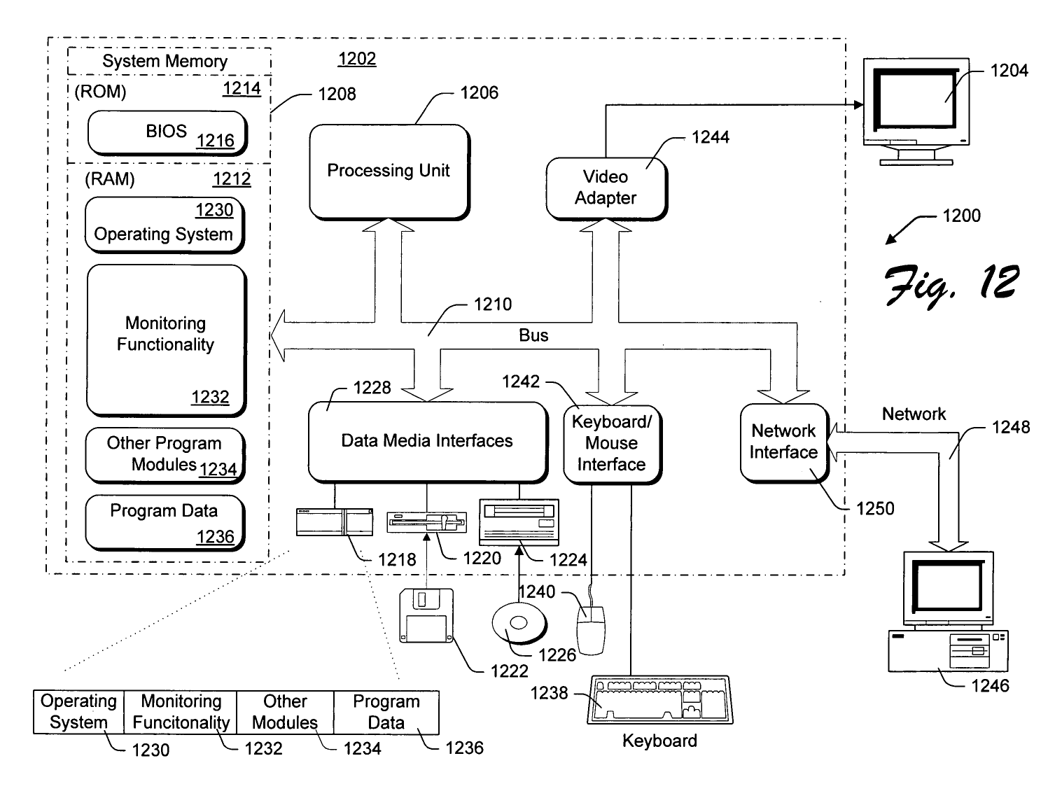

FIG. 1 shows an exemplary system 100 in which the strategies described herein can be implemented. The system 100 includes head-end message infrastructure 102 that provides multiple messages services, a collection of participant devices (104, 106, . . . 108) that utilize the head-end message infrastructure 102, and a coupling mechanism 110 that couples the above-identified system components together. Each of these components is discussed in further detail below. The devices (104, 106, . . . 108) can include any type of processing devices for sending and/or receiving messages. The devices (104, 106, . . . 108) can be implemented as general purpose computers (such as personal computers), portable computers (e.g., laptop computers, mobile telephone devices, various kinds of wearable computers, etc.), and so forth. Or the devices (104, 106, . . . 108) can refer to functionality that is integrated in an application-specific device, such as a game console (such as Microsoft I Corporation's Xbox™ game console), a set-top television box, and so forth. Or the devices (104, 106, . . . 108) can refer to units specifically designed to send and transmit messages. In any case, the devices (104, 106, . . . 108) can include any combination of computer hardware and logic functionality, including one or more processors, RAM memory, ROM memory, one or more media drives, one or more storage units, and so on. FIG. 12, to be discussed in turn, provides additional information regarding an exemplary computer environment that can be used to implement the devices (104, 106, . . . 108).

The devices (104, 106, . . . 108) can optionally include or omit logic functionality for implementing some aspect of the message service functionality. For instance, the devices (104, 106, . . . 108) can each include a first software program for implementing aspects of the E-mail service functionality and a second software program for implementing aspects of the IM service functionality. When so configured with these programs, the devices function as E-mail and IM clients. Microsoft Corporation's Outlook Express is one example of a commercially available E-mail client. Microsoft Corporation's Instant Messenger is one example of a commercially available IM client. The devices (104, 106, . . . 108) are shown as including local processing functionality (112, 114, . . . 116) to represent that they may include any combination of software and/or hardware dedicated to the transmission and receipt of messages.

However, in other implementations, the devices (104, 106, . . . 108) need not store and execute message-specific software. For instance, any of the devices (104, 106, . . . 108) can send and/or receive E-mail messages via web-enabled functionality accessible through browser logic. One example of a web-enabled E-mail message service is Microsoft Corporation's Hotmail. As described above, the general term “message service functionality” is meant to refer to any such implementation of the message services, including the software-enable client implementation and the web-enabled browser implementation.

The coupling mechanism 110 can include any kind of routing infrastructure. For instance, this coupling mechanism 110 can include any combination of wide area network, local area network, point-to-point connectivity, and so on. In one example, the coupling mechanism 110 employs some kind of network that utilizes the TCP/IP protocol, such as the Internet or an intranet. In this protocol, messages are transmitted in packets over a network infrastructure that potentially includes various routers, gateways, name servers, etc. (not shown). But the coupling mechanism 110 can also employ other kinds of networks, such as local area Ethernet networks, and so on. The communication links employed by the coupling mechanism 110 can include any combination of hardwired links, wireless links, etc.

The message service infrastructure 102 refers broadly to any infrastructure that is remote from the devices (104, 106, . . . 108). The service infrastructure 102 can be located at a single site or distributed over multiple sites; in the latter case, the parts of the service infrastructure 102 can be coupled together via the coupling mechanism 110 or via a separate coupling strategy. The message service infrastructure 102 can host multiple types of message services, such as instant messaging (IM) service 118, an E-mail messaging service 120, and one or more other types of messaging services (generally denoted by message service n 122). Although these services (118, 120, . . . 122) are shown as implemented exclusively as remote resources, aspects of these services may also be implemented in part by the devices (104, 106, . . . 108) or entirely in a peer-to-peer manner.

Remote processing functionality (124, 126, . . . 128) associated with the different message services (118, 120, . . . 122) refers to any head-end processing mechanisms employed by these services (118, 120, . . . 122). This remote processing functionality (124, 126, . . . 128) can be implemented as one or more servers dedicated to performing ascribed tasks. For instance, the remote processing functionality 126 associated with the E-mail service 120 can include various Simple Mail Transfer Protocol (SMTP) servers, various Post Office Protocol (POP3) or Internet Mail Access Protocol (IMAP) servers, and so on. SMTP servers generally process outgoing mail, while POP3 servers and IMAP servers process incoming mail. In a typical well known routing strategy, assume that Jane Doe who has an e-mail account maintained by ABC company sends an e-mail to John Smith who has an e-mail account maintained by XYZ company; if Jane Doe sends an E-mail message to John Smith, the E-mail service 120 might route the E-mail message to a server associated with the ABC company, which then sends the message to one or more servers maintained by XYZ company.

Likewise, the remote processing functionality 124 associated with the IM service 118 can include various servers dedicated to transmitting instant messages among participant devices (104, 106, . . . 108). An IM server performs the task of setting up user groups. The IM server also monitors whether group participants are logged onto their respective devices (104, 106, . . . 108) and operating online. An IM server also notifies other members of the IM group of the online status of its members. An IM user can invoke a real time communication with another IM user by clicking on a name of that IM user that appears in a user interface presentation provided by the IM service 118. In one implementation, this can prompt the transmission of an instant message from one participant device to another participant device without the assistance of the remote processing functionality 124 provided by the IM service 118.

Finally, store (130, 132, . . . 134) represents any storage functionality associated with the services (118, 120, . . . 122). Each of these stores (130, 132, . . . 134) can represent a single databases of multiple distributed databases. Each of these stores (130, 132, . . . 134) can be implemented using any kind of storage media, including magnetic storage media, solid state storage media, optical storage media, and so forth. Each of the stores (130, 132, . . . 134) can employ any kind of database management functionality to store and retrieve information from the stores (130, 132, . . . 134). As to application, in the case of the E-mail service 120, the storage 132 can be used to store E-mail messages in different accounts assigned to subscribing users. When a user accesses his or her E-mail account, the user is given the option of downloading any of their received E-mail messages to their local devices (104, 106, . . . 108). The IM service 118 may or may not store IM messages at the head-end depending on the configuration of the IM service 118.

Generally, the notification features to be described herein can be applied to any IM service paradigm and E-mail service paradigm. Accordingly, the details provided above should be interpreted as exemplary, rather than limiting. In one case, a single entity (such as a single commercial, academic or governmental entity) can supply by the IM service 118 and the E-mail service 120. For instance, the notification features to be described below can be implemented using a combination of Microsoft Corporation's Instant Messenger service and Hotmail service. In other examples, different entities can furnish the IM service 118 and the E-mail service 120. In this case, these different entities can set up contractual arrangements that permit one service to supply information to another service.

With the above introduction, FIGS. 2-4 show different scenarios that explain how the system 100 can be used to alert a user who is using a first message service of a message that has been received via another message service. In this case, a user who is using the IM service 118 can be alerted to a message received by the E-mail service 120 while the user is using the IM service. The notification specifically informs the IM user that one of the members that belongs to the IM user's IM group has sent the IM user 11 messages. (Note that the IM user can define one or more groups of individuals with whom he or she frequently communicates; these individuals can constitute one of more “IM groups” as this term is used herein). Notifications specifically reveal the identity of individuals who have sent E-mail messages to the IM user. Notifications may also specify how many E-mail messages each sender has sent to the IM user. Further details regarding the above features will be described below.

To begin with, FIG. 2 shows the case where the IM user initially logs onto the IM service 118. This prompts the IM service 118 to provide a user interface presentation that shows all of the pre-defined members of the user's IM group (or possibly, the members of multiple pre-defined IM groups). This user interface presentation also indicates whether each of the members of the IM group is online or offline. The purpose of the notification functionality at this initial stage is to determine whether any members of the IM group have sent E-mail messages to the IM user via the E-mail service 120 that have not yet been read by the IM user. In the following discussion, the term “IM user” refers to the individual who interacts with the IM service 118, e.g., via device A 104. (However, each of the members of the IM group has similarity ability to interact with the IM service 118.)

FIG. 2 shows one exemplary way of determining whether there are unread E-mail messages and for notifying the IM user of such unread E-mail messages. The steps that can be used to perform this operation are numbered to show an exemplary order in which these steps can be performed. In the first step (1), the IM user logs onto the IM service 118. In the second step (2), the IM service 118 can make an inquiry to the E-mail service 120 to determine whether there are any unread E-mail messages addressed to the IM user sent by any of the members that populate the user's IM group. This inquiry can be performed via the coupling mechanism 110 or through other communication channels. In the case where a single commercial entity provides both the IM service 118 and the E-mail service 120, the communication can be performed through propriety communication channels provided at a single head-end center or a cluster of such head-end centers associated with the single entity. In the third step (3), the E-mail service 120 responds by providing information to the IM service 118 pertaining to unread e-mail messages. Such information can include any identifying information regarding the unread E-mail messages. Preferably the information at least identifies of the person who sent the E-mail messages. The information may also optionally include a time when the E-mail messages were sent, textual information which pertains to the subject matter of the E-mail messages, and so on.

In the fourth step (4), the IM service 118 can send a notification to the IM user that alerts the IM user, via an interface associated with the IM service 118, that the IM user has received E-mail messages from members of the user's IM group. Preferably this notification specifically identifies the IM group member(s) who has sent the E-mail messages. The notification may optionally inform the user how many E-mail messages that each IM group member has sent to the user. The notification may optionally inform the IM user of the subject matter that each of the E-mail messages pertains to. This notification information therefore provides a synopsis of the content of the IM user's E-mail inbox, filtered with respect to the messages transmitted by IM group members. Upon viewing this synopsis, the IM user may then choose to invoke the E-mail service 120 itself to view and potentially respond to the received E-mail messages.

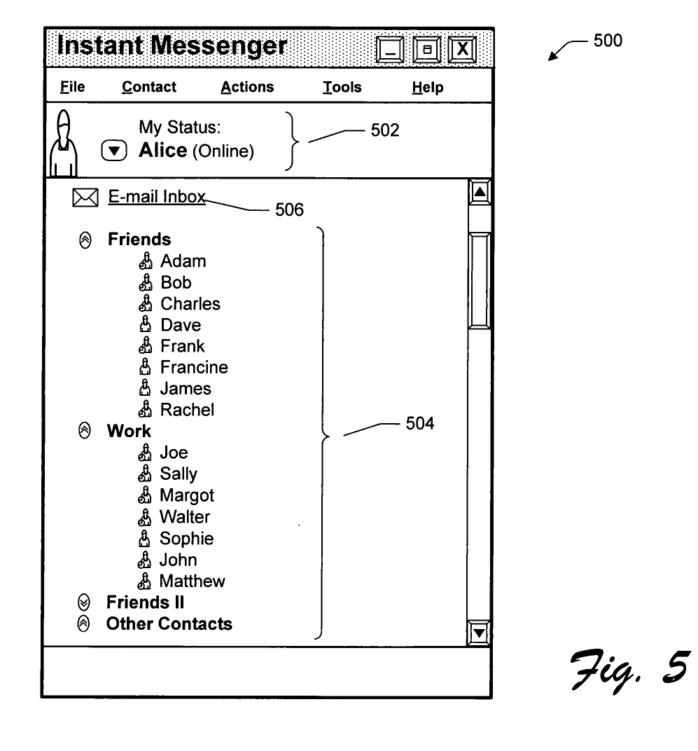

Further details regarding exemplary user interface presentations for displaying the notification information are shown in FIGS. 5-7 (to be discussed below in turn). By way of preview, one exemplary technique that can be used to notify the IM user of the identity of the person who sent the E-mail message is to display a mail icon (or other kind of 11 indicia) next to the name (or other moniker) of the sender as it appears in the IM user interface presentation. The mail icon or other indicia can also optionally provide information which indicates how many E-mail messages that each IM group member has sent the IM user. One exemplary benefit of the above-described notification functionality is that the IM user can now keep reasonably abreast of events that are taking place in other message services (e.g., in the E-mail service 120) without having to repeatedly check on those other message services. More specifically, knowing who sent the IM user an E-mail message is valuable because it allows the IM user to assess the importance of 19 the E-mail message without necessarily having to separately invoke the E-mail service 120.

FIG. 3 shows the case where the IM user has now logged onto the IM service 118 and has used it for some time. During use of the IM service 118, the IM user may receive E-mail messages from one or more of the members of the user's IM group. The sequence of steps in FIG. 3 show one exemplary way in which the IM user can be notified of such E-mail messages. In the first step (1), an IM group member using device B 106 sends an E-mail message to the IM user who is currently using device A 104. This E-mail message will eventually end up in the inbox associated with the recipient, namely the IM user of device 104. In the context of FIG. 3, step (1) indicates the E-mail message is sent to E-mail service 120 for potential storage in its storage 132. In the second step (2), the E-mail service 120 can notify the IM service 118 that it has received an E-mail message addressed to the IM user who is currently interacting with the IM service 118 using device 104. This notification can be performed upon the independent initiative of the E-mail service 120, or it can be performed upon being requested by the IM service 118, or through some other protocol. In the third step (3), the IM service 118 notifies the IM user 10 of device A 104 of the received unread E-mail from one of the members of the user's IM group. This notification can have the characteristics described above. Namely, the notification preferably identifies who sent the E-mail message.

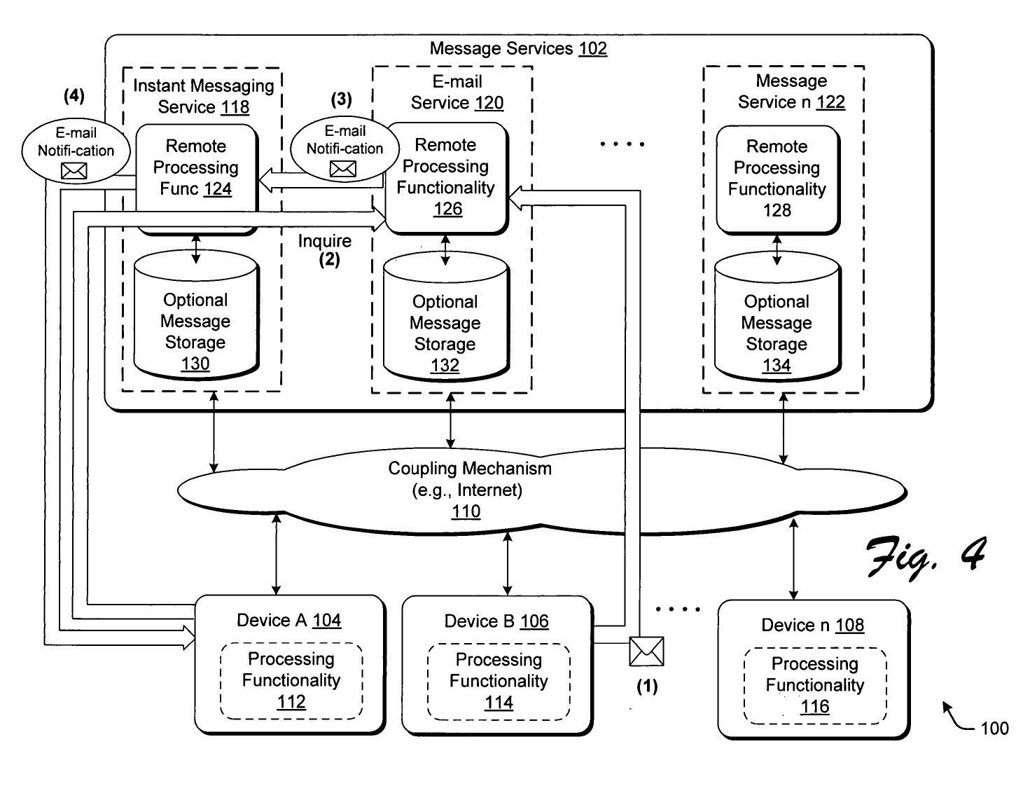

The protocol described with reference to FIG. 3 is illustrative, rather than limiting. The desired end result is that the IM user of device 104 is apprised of the arrival of an E-mail while using the IM service 118. This end result can be achieved using a different sequence of steps than is shown in FIG. 3. For instance, FIG. 4 shows one such exemplary alternative technique. In this technique, in the first step (1), an IM group member again sends an E-mail message to the user of device A 104. This E-mail message ends up in the store 132 of the E-mail service 120. In the second step (2), the user's device A 104 can periodically poll the E-mail service 120 to determine whether it contains any unread E-mail messages from IM group members addressed to the IM user of A 104. Polling requests can be specifically transmitted via the IM service 118 or can be directly transmitted to the E-mail service 120 without the involvement of the IM service 118, or can be transmitted using some other routing strategy. In the third step (3), the E-mail service 120 responds to the polling by sending a notification to the IM service 118 which alerts the IM service 118 that an unread E-mail message has been received that is addressed to the IM user who is currently using the IM service 118 on device A 104. In the fourth (4) step, the IM service 118 sends a notification to the device A 104 which alerts the IM user of the presence of the unread E-mail. Again, this notification preferably indicates who has sent the E-mail message so that the user can appropriately gauge its importance without necessarily having to activate the E-mail service 120.

Still further protocols can be used to alert IM users of E-mail messages received from IM group members.

As a final note, the above discussion was framed in the context of alerting the IM user to only E-mail messages sent by members of the user's IM group. However, the IM service 118 can also be configured to notify the IM user of E-mail messages received from senders who do not belong to the user's IM group. This can be accomplished in various ways, such as by providing a special section in the IM user interface presentation which identifies the arrival of an E-mail message from a non-IM group member; this alert notification also preferably identifies who has sent the E-mail message to the extent that this can be determined, such as by displaying the sender's E-mail address, and so forth. Still further variations on the principles described above can be implemented.

The functionality for performing the above-described operations can be implemented as software and/or hardware which is implemented in the local processing functionality (112, 114, . . . 116), the remote processing functionality (124, 126, . . . 128), or a combination of local processing functionality (112, 114, . . . 116) and remote processing functionality (124, 126, . . . 128).

And once again, the principles described above can be applied to other message services besides E-mail services and IM services. Also, the principles can be applied to the case where the user of an E-mail service is alerted, via the E-mail user interface, of an EI message transmitted via an IM service.

B. Exemplary User Interface Functionality

FIGS. 5-8 show various user interface presentations that can be used to implement the above-described functionality. To begin with, FIG. 5 shows an exemplary IM user interface presentation 500 corresponding to a state in which the IM user has received no E-mail messages. The user interface presentation 500 includes a first section 502 which indicates that the IM user, Alice, who interacts with the presentation 500, is online. The user interface presentation 500 includes a second section 504 which identifies each of the members that belong to Alice's IM group. In this case, the user, Alice, has defined several different IM groups, one devoted to Alice's friends, one devoted to Alice's co-workers, and so on. In conventional fashion, the IM user, Alice, can initiate a conversation with any member in the IM group list by clicking on the name of the group member. This prompts the activation of a separate conversation user interface box in which the IM user can type her message to the selected IM group member. Transmission of this message prompts another pop-up conversation box to appear on the selected IM group member's device. The user interface presentation 500 can also include a hypertext link (“E-mail inbox”) 506 that allows the IM user, Alice, to activate the E-mail service 120 via the user interface presentation 500.

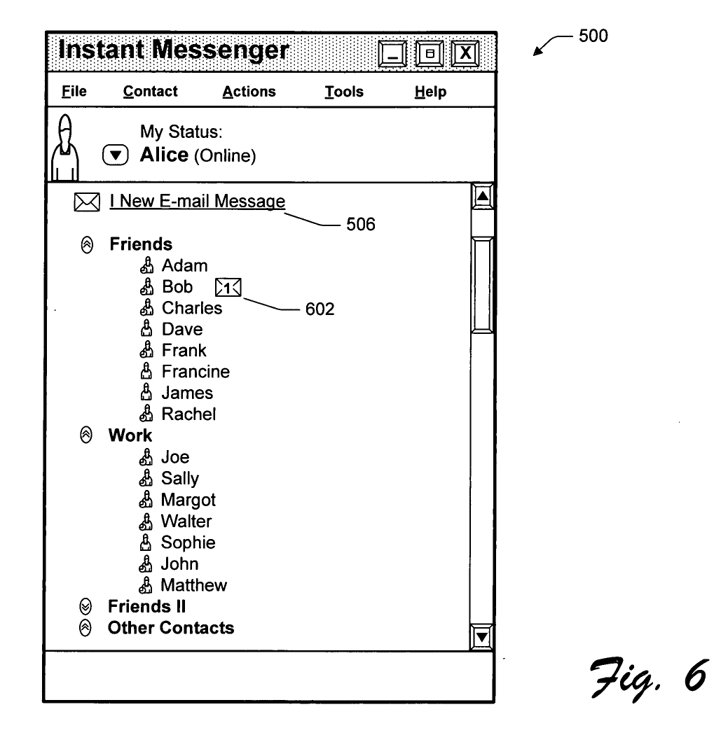

FIG. 6 shows a subsequent state of the user interface presentation 500 after one of the IM group members, e.g., Bob, has sent an E-mail message to the IM user, Alice. This causes two changes in the user interface presentation 500. First, the hypertext link 506 changes to indicate that the IM user's inbox now contains one new E-mail message. Further, an E-mail icon 602 is displayed next to Bob's name in the IM group member list to indicate the fact that Bob is the member who sent the E-mail message. This allows the IM user, Alice, to assess the importance of the E-mail message. The IM user can access the E-mail message sent by Bob by activating the hypertext link 506; this prompts the E-mail service 120 to activate the IM user's E-mail inbox to show the complete set of unread E-mail messages in the inbox, including Bob's E-mail message. Or the IM user can specifically access any unread E-mail message sent by Bob by clicking on the icon 602; this prompts the E-mail service 120 to activate the IM user's E-mail inbox to show a filtered list of E-mail messages sent by only that sender, Bob. The IM user is then free to read and respond to any E-mail message shown there in a conventional fashion.

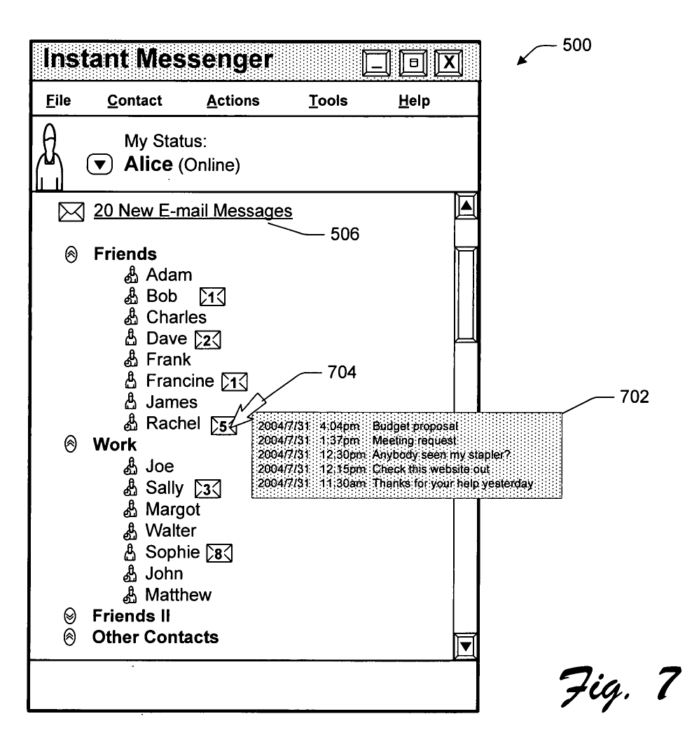

FIG. 7 shows yet another instance of the user interface presentation 500. In this I case, the IM user, Alice, has received many E-mail messages from different IM group members. Accordingly, the user interface presentation selectively provides an E-mail icon next to each IM group member who has sent at least one E-mail message to Alice. Further, each of these E-mail messages can include numeric information which indicates how many E-mail messages that the corresponding IM group member has sent to the IM user, Alice. The hypertext link 506 tallies up all of the E-mail messages that the user has received and displays this number (in this case, 20 messages). The user can review the complete set of unread E-mail messages by activating the hypertext link 506. Or the user can selectively view a filtered list of received E-mail messages sent by a particular IM group member by activating an E-mail icon next to that group member's name in the user interface presentation 500. Some members, such as Adam, may not have sent any E-mail messages to Alice that have yet to be read. Accordingly, there is no E-mail icon next to Adam's name. However, the IM service 118 can be configured such that clicking on Adam's name will display E-mail messages that Adam has sent Alice that have already been read.

According to another optional feature, the IM service 118 can include logic for identifying the subject matter of the received E-mail messages. One way of performing this function is to display synopsis information 702 in proximity to an E-mail icon when the user, Alice, moves pointer 704 in proximity to the E-mail icon. The synopsis information can identify when the E-mail message was sent and the subject matter of the E-mail message. The subject matter can be gleaned from the subject line of the E-mail messages themselves.

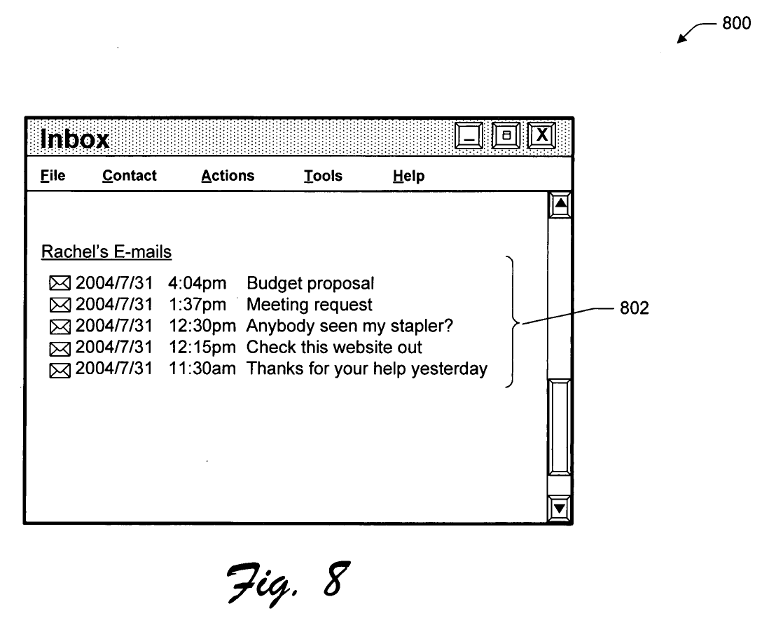

Finally, FIG. 8 illustrates an E-mail user interface presentation 800 that can be displayed as a result of the user, Alice, activating the E-mail icon adjacent to one of the IM group member's names, in this case Rachel. This prompts the E-mail service 120 to display the user interface presentation 800 that contains a list 802 of unread E-mail messages sent to Alice by Rachel. This list 802 may be a subset of the total number of E-mail messages that the IM user, Alice, has received. This allows Alice to quickly drill down and examine the group of E-mail messages that she is interested in. The IM user, Alice, can read and respond to any of these E-mail messages in the conventional manner.

The above-described user interface features are exemplary. Additional features can be added, or illustrated features can be removed, to suit individual applications. Further, instead of visual information, or to supplement the visual information, the message service functionality can alert the user to the receipt of E-mail messages via audio prompting or some other form of prompting. Audio prompting may provide a voice message or other audible cue that identifies the senders of the E-mail messages, such as by announcing the names of the senders or by displaying a jingle associated with the senders, and so on.

C. Exemplary Method of Operation

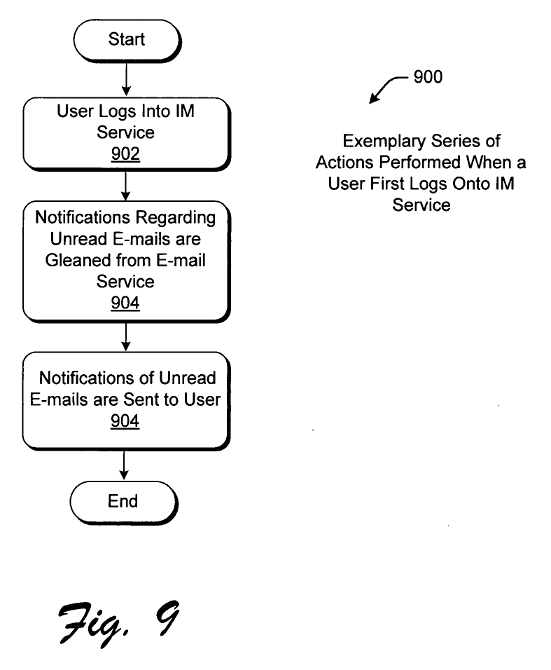

FIGS. 9-11 describe the operation of the system 100 of FIG. 1 in flow chart form. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure.

FIG. 9 shows a procedure 900 that corresponds to the scenario shown in FIG. 2 in which the IM user interface presentation is initially populated with notifications of received E-mail messages when the user first logs onto the IM service 118. In step 902, a user, e.g., Alice, logs onto the IM service 118 using device A 104. In step 904, notifications of unread E-mail messages are gleaned from the E-mail service 120. In step 904, the notifications of the unread E-mail messages are sent to the user at the device A 104.

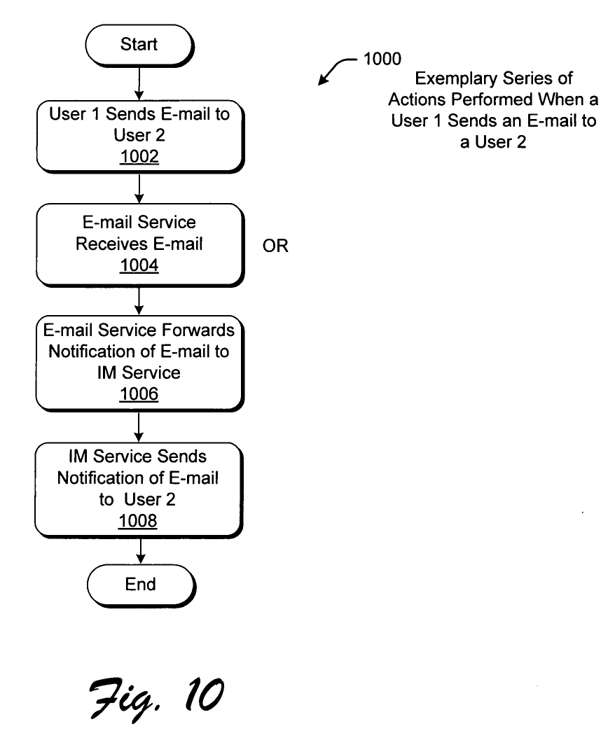

FIG. 10 shows a procedure 1000 that corresponds to the scenario shown in FIGS. 3 or 4 in which an already activated IM user interface presentation receives a notification that a first user has sent an E-mail message to a second user, where the second user corresponds to the IM user, e.g., Alice, who is interacting with the IM user interface presentation at the device A 104. In step 1002, the first user sends an E-mail message to the second user, e.g., Alice. In step 1004, the E-mail service 120 receives the E-mail message. In step 1006, the E-mail service 120 forwards a notification of the received E-mail message to the IM service 118. This operation can be performed by the E-mail service 120 in unprompted fashion, that is, automatically upon receipt of the E-mail message from the first message service. Or this operation can be performed upon the polling request of the IM service 118 or in response to some other request. In step 1108, the IM service 118 forwards a notification of the received E-mail message from the first user to the second user, e.g., Alice, who is using device A 104.

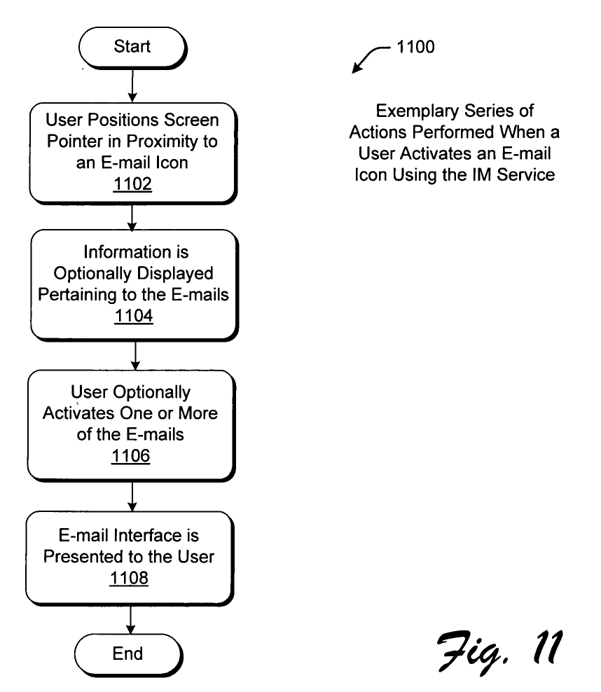

FIG. 11 defines a procedure 1100 that shows an exemplary series of steps that an IM user can perform to retrieve an E-mail message via the IM user interface presentation. In step 1102, the IM user can position a screen pointer in proximity to an E-mail icon that is shown adjacent to one of the IM group members in the IM user interface presentation. In step 1104, the IM service 118 responds by optionally displaying descriptive information next to the E-mail icon. This descriptive information can identify the time when the E-mail message(s) from this particular group member were sent, as well as the subject matter of the message(s). FIG. 8 shows one interface strategy for implementing this feature. In step 1106, the IM user can optionally activate one or more of the E-mail messages by clicking on the E-mail icon positioned adjacent to the IM member, or by clicking on the descriptive information associated with the E-mail icon. In step 1108, the E-mail service 120 responds to the user's actions by displaying the user's E-mail inbox. The E-mail inbox can include unread (and/or read) E-mail messages specifically filtered to show only those originating from the identified IM group member. FIG. 9 shows one exemplary way that this user interface feature can be implemented.

D. Exemplary Computer Environment

In one exemplary implementation, certain aspects of the IM service functionality and the E-mail service functionality can be implemented as computer code executed by the participant devices (104, 106, . . . 108). In this case, FIG. 12 provides information regarding an exemplary computer environment 1200 that can be used to implement such message service functionality. (In addition, FIG. 12 can also describe components of a server computer provided at the message source site 102.)

The computing environment 1200 includes a general purpose or sever type computer 1202 and a display device 1204. However, the computing environment 1200 can include other kinds of computing equipment. For example, although not shown, the computer environment 1200 can include hand-held or laptop devices, set top boxes, game consoles, mainframe computers, etc. Further, FIG. 12 shows elements of the computer environment 1200 grouped together to facilitate discussion. However, the computing environment 1200 can employ a distributed processing configuration. In a distributed computing environment, computing resources can be physically dispersed throughout the environment.

Exemplary computer 1202 includes one or more processors or processing units 1206, a system memory 1208, and a bus 1210. The bus 1210 connects various system components together. For instance, the bus 1210 connects the processor 1206 to the system memory 1208. The bus 1210 can be implemented using any kind of bus structure or combination of bus structures, including a memory bus or memory controller, a peripheral bus, an accelerated graphics port, and a processor or local bus using any of a variety of bus architectures.

Computer 1202 can also include a variety of computer readable media, including a variety of types of volatile and non-volatile media, each of which can be removable or non-removable. For example, system memory 1208 includes computer readable media in the form of volatile memory, such as random access memory (RAM) 1212, and non-volatile memory, such as read only memory (ROM) 1214. ROM 1214 includes an input/output system (BIOS) 1216 that contains the basic routines that help to transfer information between elements within computer 1202, such as during start-up. RAM 1212 typically contains data and/or program modules in a form that can be quickly accessed by processing unit 1206.

Other kinds of computer storage media include a hard disk drive 1218 for reading from and writing to a non-removable, non-volatile magnetic media, a magnetic disk drive 1220 for reading from and writing to a removable, non-volatile magnetic disk 1222 (e.g., a “floppy disk”), and an optical disk drive 1224 for reading from and/or writing to a removable, non-volatile optical disk 1226 such as a CD-ROM, DVD-ROM, or other optical media. The hard disk drive 1218, magnetic disk drive 1220, and optical disk drive 1224 are each connected to the system bus 1210 by one or more data media interfaces 1228. Alternatively, the hard disk drive 1218, magnetic disk drive 1220, and optical disk drive 1224 can be connected to the system bus 1210 by a SCSI interface (not shown), or other coupling mechanism. Although not shown, the computer 1202 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 1202. For instance, the readable media can store the operating system 1230, application-specific functionality 1234 (including functionality for implementing aspects of the IM service and the E-mail service), other program modules 1234, and program data 1236.

The computer environment 1200 can include a variety of input devices. For instance, the computer environment 1200 includes the keyboard 1238 and a pointing device 1240 (e.g., a “mouse”) for entering commands and information into computer 1202. The computer environment 1200 can include other input devices (not illustrated), such as a microphone, joystick, game pad, satellite dish, serial port, scanner, card reading devices, digital or video camera, etc. Input/output interfaces 1242 couple the input devices to the processing unit 1206. More generally, input devices can be coupled to the computer 1202 through any kind of interface and bus structures, such as a parallel port, serial port, game port, universal serial bus (USB) port, etc.

The computer environment 1200 also includes the display device 1204. A video adapter 1244 couples the display device 1204 to the bus 1210. In addition to the display device 1204, the computer environment 1200 can include other output peripheral devices, such as speakers (not shown), a printer (not shown), etc.

Computer 1202 operates in a networked environment using logical connections to one or more remote computers, such as a remote computing device 1246. The remote computing device 1246 can comprise any kind of computer equipment, including a general purpose personal computer, portable computer, a server, etc. Remote computing device 1246 can include all of the features discussed above with respect to computer 1202, or some subset thereof. In the context of the system 100 FIG. 4, the remote computer 1246 can represent one of the computer servers used in the message service infrastructure 102, etc.

Any type of network 1248 can be used to couple the computer 1202 with remote computing device 1246, such as the WAN 402 of FIG. 4, a LAN, etc. The computer 1202 couples to the network 1248 via network interface 1250 (e.g., the interface 416 shown in FIG. 4), which can utilize broadband connectivity, modem connectivity, DSL connectivity, or other connection strategy. Although not illustrated, the computing environment 1200 can provide wireless communication functionality for connecting computer 1202 with remote computing device 1246 (e.g., via modulated radio signals, modulated infrared signals, etc.).

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for notifying a user of a first message service of the arrival of a message received via a second message service, comprising:
activating the first message service to provide a user interface associated with the first message service;
receiving a notification that alerts the user that a sender has sent the user a message via the second message service; and
presenting the notification via the user interface provided by the first message service, wherein the notification identifies the sender of the message.

2. The method according to claim 1, wherein the first message service is an instant messaging (IM) service and the second message service is an E-mail service.

3. The method according to claim 1, wherein the user interface is a visual user interface presentation that displays member information defining a group of members who may communicate with one another via the first message service, wherein the member information includes information that identifies the sender of the message.

4. The method according to claim 3, wherein the notification identifies the sender of the message by presenting visual indicia in proximity to the information that identifies the sender within the member information.

5. The method according to claim 4, wherein the visual indicia also indicates how many messages that the sender has sent the user.

6. The method according to claim 1, wherein the notification also identifies a subject of the message.

7. The method according to claim 1, wherein the user interface provides additional information regarding the notification in response to the user's selective inquiry regarding the notification.

8. The method according to claim 8, wherein the user interface is a visual user interface presentation that provides the notification thereon, and wherein the user selectively inquires about the notification by moving a pointer in proximity to the notification.

9. The method according to claim 1, where the user activates the message by activating information associated with the message presented on the user interface.

10. The method according to claim 9, wherein the activation of the message prompts the presentation of another user interface associated with the second message service.

11. The method according to claim 10, wherein the other user interface includes a filtered list of messages sent to the user by the sender.

12. A processor readable medium including machine readable instructions for implementing the activating, receiving and presenting of claim 1.

13. An apparatus for notifying a user of a first message service of the arrival of a message received via a second message service, comprising:
logic configured to activate the first message service to provide a first message service user interface;
logic configured to receive a notification that alerts the user that a sender has sent the user a message via the second message service; and
logic configured to present the notification via the user interface provided by the first message service, wherein the notification identifies the sender of the message.

14. The apparatus according to claim 13, wherein the first message service is an instant messaging (IM) service and the second message service is an E-mail service.

15. The apparatus according to claim 13, wherein the user interface is a visual user interface presentation that is configured to display member information defining a group of members who may communicate with one another via the first message service, wherein the member information includes information that identifies the sender of the message.

16. The apparatus according to claim 15, wherein the notification is configured to identify the sender of the message by presenting visual indicia in proximity to the information that identifies the sender within the member information.

17. The apparatus according to claim 16, wherein the visual indicia is also configured to indicate how many messages that the sender has sent the user.

18. The apparatus according to claim 13, wherein the notification is also configured to identify a subject of the message.

19. The apparatus according to claim 13, wherein the user interface is configured to provide additional information regarding the notification in response to the user's selective inquiry regarding the notification.

20. The apparatus according to claim 19, wherein the user interface is a visual user interface presentation that is configured to provide the notification thereon, and wherein the user interface is configured to provide the additional information in response to the user moving a pointer in proximity to the notification.

21. The apparatus according to claim 13, wherein the apparatus includes activation logic for allowing the user to activate the message by activating information associated with the message presented on the user interface.

22. The apparatus according to claim 21, wherein the activation logic is configured to prompt the presentation of another user interface associated with the second message service.

23. The apparatus according to claim 22, wherein the other user interface is configured to include a filtered list of messages sent to the user by the sender.

24. A processor readable medium including machine readable instructions for implementing each of the logic recited in claim 13.

25. A method for notifying a user of a first message service of the arrival of a message received via a second message service, comprising:
receiving, by the first message service, a notification that a sender has sent the user a message via the second message service; and
forwarding, by the first message service, the notification to the user, wherein the notification identifies the sender of the message.

26. The method according to claim 25, wherein the first message service is an instant messaging (IM) service and the second message service is an E-mail service.

27. A processor readable medium including machine readable instructions for implementing the receiving and the forwarding recited in claim 25.

28. An apparatus implemented by a first message service for notifying a user who is interacting with the first message service of the arrival of a message received via a second message service, comprising:
logic configured to receive a notification that a sender has sent the user a message via the second message service; and
logic configured to forward the notification to the user, wherein the notification identifies the sender of the message.

29. The apparatus according to claim 28, wherein the first message service is an instant messaging (IM) service and the second message service is an E-mail service.

30. A processor readable medium including machine readable instructions for implementing each of the logic recited in claim 28.

31. A system, comprising:
first remote message service functionality for providing a first message service to a user according to a first message technique;
second remote message service functionality for providing a second message service to the user according to a second message technique;
a user device which enables the user to interact with the first remote message functionality and the second remote message service functionality; and
communication coupling which connects the user device to the first remote message service functionality and the second remote message service functionality;
wherein the first remote message service functionality includes logic configured to receive a notification from the second remote message service functionality that a sender has sent the user a message via the second message service functionality, and to forward the notification to user device for receipt by the user, wherein the notification identifies the sender of the message.

32. The system according to claim 31, wherein the first message service is an instant messaging (IM) service and the second message service is an E-mail service.
